(19) United States
(12) Patent Application Publication
(10) Pub. No.: US 2026/0037311 A1
(43) Pub. Date: Feb. 5, 2026

(54) SCHEDULING AN EXECUTION OF A SOFTWARE APPLICATION BASED ON A SOFTWARE INVENTORY

(71) Applicant: RED HAT, INC., Raleigh, NC (US)

(72) Inventors: Leigh Griffin, Waterford (IE); Leonardo Rossetti, San Paulo (BR)

(21) Appl. No.: 18/794,083

(22) Filed: Aug. 5, 2024

(51) Int. Cl. G06F 9/50

(52) U.S. Cl. CPC G06F 9/5027

(57) ABSTRACT

An application scheduler can schedule an execution of a software application based on compliance with a safety standard and an availability of system resources. The application scheduler can determine, based on a software inventory, that the software application is associated with the safety standard. The software inventory can include metadata corresponding to the software application. The application scheduler additionally can determine, based on the metadata of the software inventory, a set of system resources used to execute the software application. Subsequently, the application scheduler can schedule an execution of the software application based on the availability of the set of system resources.

### TECHNICAL FIELD

The present disclosure relates generally to software deployment and evaluation. More specifically, but not by way of limitation, this disclosure relates to scheduling an execution of a software application based on a software inventory of the software application to facilitate safety compliance.

### BACKGROUND

Many organizations around the globe have developed functional safety standards for software and electronics. Functional safety relates to reducing risks so that computing systems function safely in the event that there is a malfunction. One example of a functional safety standard is ISO 26262 for automotive electronics. Functional safety standards can be used to avoid or mitigate systematic failures and hardware failures to prevent hazardous operational situations. An operating system can be certified to a functional safety standard based on a target level of risk reduction. For example, an Automotive Safety Integrity Level (ASIL) assignment with respect to ISO 26262 has four possible levels of safety requirements: ASIL A, ASIL B, ASIL C, and ASIL D. ASIL D has the highest safety requirements of the four possible levels and includes the safety requirements of the three preceding levels.

### BRIEF DESCRIPTION OF THE DRAWINGS

FIG. 1 is a block diagram of an example of a computing environment for scheduling software execution using one or more software inventories to facilitate safety compliance according to some examples of the present disclosure.

FIG. 2 is a block diagram of another example of a computing environment for scheduling software execution using one or more software inventories to facilitate safety compliance according to some examples of the present disclosure.

FIG. 3 is a flowchart of a process for scheduling software execution using one or more software inventories to facilitate safety compliance according to some examples of the present disclosure.

### DETAILED DESCRIPTION

A software developer or software development organization may want or need to comply with a functional safety standard issued by a standard-setting organization when developing or executing a software application. The software application that is compliant with the functional safety standard may run in a computing environment that includes other software applications that may or may not comply with the functional safety standard. In some cases, software applications that are noncompliant with the functional safety standard may interfere with an execution of the software application that is compliant with the functional safety standard. For instance, a computing environment may have limited system resources that can be used to execute the software applications, which can result in resource contention. Due to possible conflicts among compliant and noncompliant software applications of the computing environment, an application scheduler can have difficulty scheduling a respective execution of each software application in the computing environment. Interfering with the software applications that are compliant with the functional safety standard can cause unpredictable behavior that can result in failures or malfunctions associated with the computing environment.

Some examples of the present disclosure can overcome one or more of the issues mentioned above by scheduling the execution of the software applications in the computing environment using software inventories. Each software application of the computing environment can have a corresponding software inventory. The software inventories can store metadata that describes respective subcomponents, dependencies, or licenses of each software application. For instance, the metadata can describe information about libraries, tools, or processes used to develop, build, or deploy the software applications. Additionally, the software inventories can describe a respective creation history of each software application, such as details related to third-party code origins. The application scheduler can use the software inventories to determine which of the software applications are compliant with or noncompliant with a functional safety standard provided by a standard-setting organization. In other words, based on the metadata of the software inventories, the application scheduler can identify compliant software applications, such as a subset of the software applications that are compliant with the functional safety standard. Similarly, the application scheduler can use the metadata provided by the software inventories to classify the remaining software applications as noncompliant software application that are noncompliant with the functional safety standard. Additionally, the application scheduler can analyze the software inventories to determine a respective set of system resources to run the software applications corresponding to the software inventories.

Once the application scheduler has identified the compliant software applications, the application scheduler can manage the execution of the software applications to minimize resource contention and resource exhaustion. In particular, the application scheduler can monitor an availability of the system resources in the computing environment to determine suitable actions with respect to the execution of the software applications. In some cases, the application scheduler can delay or prevent the execution of certain software applications. For instance, the application scheduler can prioritize executing the compliant software applications to prevent resource contention between the compliant software applications and the noncompliant software applications. In other cases, the application scheduler may partially execute a particular software application based on the availability of the system resources.

In one particular example, a computing environment can include one or more software applications. An application scheduler of the computing environment can manage a scheduling queue that corresponds to a respective execution of the software applications of the computing environment. The scheduling queue can indicate an order in which the software applications are assigned to be executed. The application scheduler can obtain a respective software inventory of each software application in the computing environment to extract metadata corresponding to each software application. For example, the computing environment can include a software inventory tool that can generate a software inventory for a particular software application. The application scheduler can extract the metadata from each software inventory using application programming interfaces (APIs) associated with the software inventories of the software applications. Each software inventory can provide a respective nested inventory indicating one or more components of a corresponding software application. Based on the metadata provided by the software inventories, the application scheduler can determine a respective minimum set of system resources needed to execute each software application. For example, a particular application may require a certain number of processor cores or a certain amount of memory to successfully execute.

Additionally, the application scheduler can monitor the system resources of the computing environment to determine an availability of the system resources. For example, the application scheduler can determine a current availability of the system resources. The application scheduler additionally can predict which system resources may be available in the future, such as at a predefined time. Based on the availability of the system resources and the system resources needed to execute each software application, the application scheduler can assign certain software applications to the scheduling queue to be executed. If available system resources are insufficient to execute a particular software application, the application scheduler can avoid the execution of the particular software application until sufficient system resources are available. In some cases in which multiple software applications are competing for the same system resource, the application scheduler can prioritize the execution of the software applications based on compliance with a safety standard. In particular, compliant applications can be prioritized over noncompliant applications to ensure suitable safety assurance.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

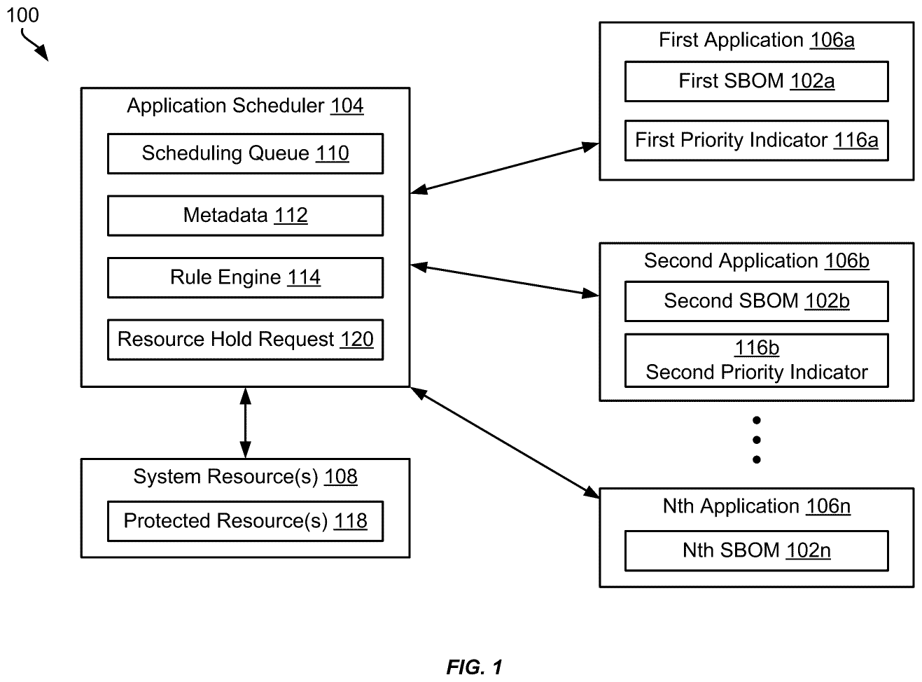

FIG. 1 is a block diagram of an example of a computing environment 100 for scheduling software execution using one or more software inventories (e.g., software bill of materials (SBOMs) 102a-n) to facilitate safety compliance according to some examples of the present disclosure. In some examples, components within the computing environment 100 may be communicatively coupled via communication protocols or via a network, such as a local area network (LAN), wide area network (WAN), the Internet, or any combination thereof. For example, the computing environment 100 can include an application scheduler 104 that is communicatively coupled with one or more software applications 106 (e.g., a first software application 106a or a second software application 106b). The computing environment 100 can include any number of software applications, such as up to an nth software application 106n. In some examples, the computing environment 100 can correspond to a computing device, such as a desktop computer, laptop computer, server, mobile phone, or tablet.

The computing environment 100 can include system resources 108, such as storage, memory, processing power, or a combination thereof. The system resources 108 can correspond to physical components (e.g., hardware) or virtual components of the computing environment 100 that have limited availability, such as a limited amount accessible by the software applications 106a-n. An availability of the system resources 108 can vary over time such that a current availability of the system resources 108 may be different than an updated availability of the system resources 108 determined at a later time. For instance, as the software application 106a-n are executed, the software applications 106a-n may occupy portions of the system resources 108 to provide certain functionalities (e.g., word processing, printing, interfacing with hardware equipment, etc.). During or after the execution of the software applications 106a-n, the software applications 106a-n may release the occupied portions of the system resources 108 such that other software applications can access the system resources 108. In some cases, the computing environment 100 can correspond to an edge device of a distributed computing system (e.g., a computing cluster or a cloud computing environment). The edge device can be a resource-constrained device that has restrictions with respect to storage, processing capabilities, power input, or a combination thereof.

A lack of sufficient system resources can cause interference between or among the software applications 106a-n with respect to having access to the system resources 108 used to run the software applications 106a-n. The interference resulting from the lack of sufficient system resources can be referred to as resource interference. In some implementations, the interference of the software applications 106a-n can involve temporal interference that can be associated with conflicting use of a shared system resource (e.g., resource contention). Examples of the temporal interference can include scheduling interference or execution interference. The temporal interference can result in deadlocks, livelocks, or otherwise block the execution of software applications affected by the temporal interference. In some cases, resource contention can cause a particular software application to fail to acquire sufficient system resources to successfully execute, thereby resulting in crashes, failures, or other malfunctions of the computing environment 100.

To distribute the system resources 108 between or among the software applications 106a-n, the application scheduler 104 can determine an order by which to execute the software applications 106a-n based on certain criteria. For example, the application scheduler 104 can schedule the execution of the software applications 106a-n based on available system resources, compliance with a safety standard, or a combination thereof. Additionally or alternatively, the application scheduler 104 can control the execution of the software applications 106a-n by pausing or resuming the execution of certain software applications. A scheduling queue 110 of the application scheduler 104 can indicate the order of executing the software applications 106a-n. In some examples, the application scheduler 104 can prevent the execution of the software applications 106a-n until sufficient system resources are available. The application scheduler 104 can determine a respective set of the system resources 108 used by each software application to successfully run. If at least one system resource in a particular set of the system resources 108 is unavailable (e.g., in use by a different software application), there may be insufficient system resource to schedule the execution of a corresponding software application.

For example, the first software application 106a and the second software application 106b may both use a particular hardware peripheral (e.g., a printer, external hard drive, etc.) when running. In other words, a predicted resource consumption of the second software application 106b may conflict with a particular set of the system resources 108 used to execute the first software application 106a. To avoid resource contention, the application scheduler 104 may schedule the first software application 106a and the second software application 106b to run at different times. In particular, the application scheduler 104 may prevent the second software application 106b from running until the particular hardware peripheral is available to use. In other words, the application scheduler 104 can determine that the particular hardware peripheral will be available at a predefined time, such as based on a predicted usage of the particular hardware peripheral by the first software application 106a. Once the application scheduler 104 predicts a future availability of the particular hardware peripheral, the application scheduler 104 can schedule the execution of the second software application 106b to occur at or after the predefined time. Accordingly, the second software application 106b can be successfully executed with sufficient system resources including the particular hardware peripheral.

As another example, the application scheduler 104 may prioritize executing the first software application 106a if the first software application 106a is compliant with the safety standard and the second software application 106b is noncompliant. To reduce a likelihood of interference affecting the first software application 106a, the application scheduler 104 may schedule the first software application 106a to run prior to the second software application 106b. Additionally or alternatively, the application scheduler 104 can prevent the execution of the second software application 106b while the first software application 106a is running. Accordingly, the application scheduler 104 can prevent the second software application 106b from interfering with functionalities provided by the first software application 106a.

In some cases, the application scheduler 104 can schedule a partial execution of a particular software application (e.g., the first software application 106a, the second software application 106b, or a combination thereof). In particular, the application scheduler 104 may determine that a portion of the particular software application lacks sufficient system resources to be executed. The application scheduler 104 then can schedule the partial execution of the particular software application such that a remaining portion of the particular software application is executed. For example, if the software applications 106a-n have overlapping resource usage, the application scheduler 104 can partially execute at least one software application to prevent resource contention.

In some implementations, the application scheduler 104 may schedule the execution of the software applications 106a-n such that the first software application 106a fully executes while the second software application 106b partially executes. For instance, a portion of the second software application 106b may run prior to or contemporaneously with the execution of the first software application 106a. In other implementations, the application scheduler 104 may control the execution of the software applications 106a-n such that both the first software application 106a and the second software application 106b partially execute. For instance, the application scheduler 104 can determine (e.g., using a first SBOM 102a or a second SBOM 102b) a respective portion of the software applications 106a-b that can be executed without resource contention. The application scheduler 104 then can execute the respective portion of each software application while preventing a respective remaining portion of the software applications 106a-n from running, thereby avoiding resource interference.

As stated above, the application scheduler 104 can schedule the execution of the software applications 106a-n based on which system resources are available or are predicted to be available at a later time. For instance, the application scheduler 104 can have access to a respective SBOM of the software applications 106a-n, which can include certain software applications that are currently running. Accordingly, the application scheduler 104 can determine which system resources 108 are in use. In some examples, the application scheduler 104 can monitor the system resources 108 to determine the availability of the system resources 108. For example, the application scheduler 104 can determine a current availability of the system resources 108 or predict a future availability of the system resources 108 at a later point in time. In some cases, the application scheduler 104 can include a monitoring module that can collect usage data of the system resources 108, such as central processing unit (CPU) or random-access memory (RAM) capacities. The usage data of the system resources 108 can indicate whether a particular system resource is currently in use, which software application is using the particular system resource and for how long, etc. If the particular system resource, such as memory, can be used by multiple software applications, the usage data can identify each software application using the particular system resource. Additionally, the usage data may indicate a respective proportion or amount of the particular system resource being used by each software application.

As illustrated in FIG. 1, the first software application 106a can include the first SBOM 102a. Similarly, the second software application 106b can include the second SBOM 102b that can be different from the first SBOM 102a. Each SBOM of the software applications 106a-n can provide metadata 112 that can describe contents, dependencies, build history, or a combination thereof of a corresponding software application. In particular, the SBOMs 102a-n can provide a standardized approach to describe software composition of the software applications 106a-n and where components of the software applications 106a-n are declared. In some examples, each SBOM can provide a respective set of metadata specific to a corresponding software application of each SBOM. For example, the first SBOM 102a may provide a first set of metadata, and the second SBOM 102b may provide a second set of metadata different from the first set of metadata. The metadata 112 analyzed by the application scheduler 104 can correspond to the sets of metadata provided by the SBOMs 102a-n.

Based on the metadata 112, the application scheduler 104 can predict or determine a respective resource usage of each software application in the computing environment 100. In some cases, the metadata 112 of the SBOMs 102a-n can describe a minimum set of the system resources 108 consumed by a corresponding software application to be successfully scheduled to run. If at least one system resource of the minimum set is unavailable to be accessed by the corresponding software application, the application scheduler 104 may be unable to schedule the execution of the corresponding software application. The minimum set of resources can include memory, storage, numbers of processing cores, specific hardware peripherals, or a combination thereof. By providing visibility with respect to the components of the software applications 106a-n, the SBOMs 102a-n can facilitate resource allocation as well as vulnerability detection and mitigation.

The SBOMs 102a-n may be generated using source code, during build time, during runtime, or while analyzing the software applications 106a-n. In some examples, an SBOM tool can be used to generate at least one SBOM of the SBOMs 102a-n using the source code of the software applications 106a-n. Additionally or alternatively, generating a subset of the SBOMs can involve using a plugin to generate the at least one SBOM during build time. For example, the plugin can be part of a code development environment to automatically generate a specific SBOM corresponding to a particular software application being built using the code development environment. Additionally, in some cases, a different SBOM can be generated to correspond to each version of a particular software application. For example, if the particular software application is updated, an updated SBOM corresponding to an updated version of the particular software application can be generated. The updated SBOM can describe or otherwise include changes made to the particular software application to generate the updated version of the particular software application.

In some examples, a particular SBOM can be packaged with a corresponding software application. For example, the software applications 106a-n can be distributed as part of one or more container images that are compliant with the Open Container Initiative (OCI). The OCI is an open governance structure to enable standardized container formats and runtimes. The container images that are compliant with the OCI can include suitable APIs that enable the application scheduler 104 to access the SBOMs 102a-n of the software applications 106a-n. If the software applications 106a-n are distributed as non-containerized images, the SBOMs 102a-n can be extracted using the SBOM tool.

Additionally, the application scheduler 104 can analyze the SBOMs 102a-n to determine whether the software applications 106a-n are compliant with or noncompliant with the safety standard. Accordingly, the application scheduler 104 can schedule the execution of the software applications 106a-n based on whether each software application is associated with or unassociated with the safety standard. A subset of the software applications 106a-n that are associated with the safety standard can be considered to be compliant with the safety standard. Conversely, another subset of the software applications 106a-n that are unassociated with the safety standard can be considered to be noncompliant with the safety standard. A particular software application being compliant with the safety standard can indicate safety assurance of the particular software application. For example, a subset of the software applications 106a-n can undergo risk analysis to determine that a respective risk level of each software application in the subset is below a predefined threshold, thereby being compliant with the safety standard.

The safety standard can be overseen by a standard-setting organization or a regulatory authority, such as the International Organization for Standardization (ISO). In some examples, the safety standard can be a functional safety standard associated with vehicles, machinery, software, or devices (e.g., in transportation, construction, or medical applications). The functional safety standard can ensure suitable safety assurance to minimize risk of physical injury or damage to humans directly or indirectly through an implementation of one or more automatic protection functions. Additionally, compliance-related policies (e.g., the Health Insurance Portability and Accountability Act (HIPAA), etc.) may similarly involve safety standards to provide certification or assurance with respect to safety or data privacy.

The application scheduler 104 can classify each software application based on its compliance with the safety standard. A portion of the software applications 106a-n that are compliant with the safety standard can be referred to as compliant applications. The remaining portion of the software applications 106a-n that are noncompliant with the safety standard can be referred to as noncompliant applications. In some cases, the compliant applications can provide certain functionalities to ensure compliance with the safety standard. The noncompliant applications may be unassociated with or otherwise unrelated to the safety standard. To determine whether the software applications 106a-n are compliant with the safety standard, the application scheduler 104 can access a respective SBOM of each software application.

In some cases, the application scheduler 104 additionally may determine a particular safety level (e.g., a particular Automotive Safety Integrity Level (ASIL)) of the compliant applications. Classifying the software applications 106a-n based on compliance with the safety standard can involve determining whether certain identifiers or key characteristics are included in the software applications 106a-n. The identifiers or the key characteristics can indicate or be suggestive of compliance with the safety standard. Examples of the identifiers or key characteristics associated can include linkage during compilation, interrupt request (IRQ) handlers, exception handlers, defining application programming interface (API) calls, or a combination thereof. In some implementations, the application scheduler 104 can analyze the SBOMs 102a-n with respect to the APIs of the software applications 106a-n to determine the compliance of the software applications 106a-n with the safety standard. Additionally or alternatively, the application scheduler 104 can analyze the SBOMs 102a-n with respect to one or more annotations provided in the metadata 112 of the SBOMs 102a-n, such as at a package level or at a service level. Examples of the annotations can include comments, notes, additional code, etc. As a specific example, a particular annotation provided in a corresponding SBOM may include a particular identifier to indicate compliance with the safety standard.

In some examples, the application scheduler 104 can execute a rule engine 114 that can use the metadata 112 of the SBOMs 102a-n to classify the software applications 106a-n. The rule engine 114 can apply at least one rule set to classify the software applications 106a-n based on whether each software application is compliant with or noncompliant with the safety standard. For example, the rule engine 114 can use the metadata 112 of the SBOMs 102a-n as input to evaluate whether each software application includes the identifiers associated with the safety standard. The rule engine 114 then can output a respective indication corresponding to each software application that indicates whether a corresponding software application is a compliant application or a noncompliant application.

Additionally or alternatively, the application scheduler 104 can use pattern matching to determine whether the software applications 106a-n are compliant or noncompliant with the safety standard. In some cases, the application scheduler 104 can compare the metadata 112 provided by the SBOMs 102a-n of the software applications 106a-n to at least one pattern that is indicative of compliance or noncompliance with the safety standard. Additionally or alternatively, the application scheduler 104 may apply pattern matching using one or more regular expressions. A regular expression can also be referred to as a regex. The regular expressions can include a sequence of characters that can specify a match pattern that can be used to perform the pattern matching with respect to the SBOMs 102a-n of the software applications 106a-n. The sequence of characters can include one or more alphanumeric characters. Additionally, the regular expressions can include one or more special characters that can provide a specific matching pattern. For example, a plus character (e.g., ‘+’) can be used to find a match corresponding to a preceding subexpression, such as using ‘io+’ to find ‘ionic’ and ‘iodine’. As another example, ‘\s’ can be used to find white-space characters.

In some implementations, the application scheduler 104 can execute a machine-learning model to determine whether the software applications 106a-n are compliant with the safety standard. For instance, the machine-learning model can be trained using a training process (e.g., supervised training or unsupervised training) to use the SBOMs 102a-n as input and generate an output to indicate the compliant applications. The training process can involve using historical data to adjust certain parameters of the machine-learning model. In particular, training the machine-learning model can involve making iterative adjustments to the parameters of the machine-learning model to minimize a loss function of the machine-learning model. The loss function of the machine-learning model can be defined based on variables (e.g., the identifiers described above) related to compliance of the software applications 106a-n with the safety standard.

Although separate components or processes are described herein with respect to classifying the software applications 106a-n based on compliance with the safety standard, it will be appreciated that a combination of the components or processes described herein may be applied. In any case, once the application scheduler 104 identifies the compliant and noncompliant applications, the application scheduler 104 can use a respective classification of each software application to schedule the execution of the software applications 106a-n. For example, based on the indication(s) outputted by the rule engine 114, the application scheduler 104 can assign a respective priority indicator (e.g., a first priority indicator 116a or a second priority indicator 116b) to each software application. The application scheduler 104 can prioritize the execution of the compliant applications, for example to minimize risk associated with the computing environment 100 or the software applications 106a-n. In some cases, the risk can correspond to a likelihood of harm (e.g., physical injury, damage to property or to an environment, etc.) occurring as a result of software malfunction or failure. Due to the compliant applications being associated with safety assurance, the likelihood of harm occurring may be greater if the compliant applications malfunction or fail to execute compared to the noncompliant applications.

As an example, the first software application 106a can be a compliant application while the second software application 106b can be a noncompliant application. Accordingly, the application scheduler 104 can assign the first priority indicator 116a to the first software application 106a that indicates a higher priority level than the second priority indicator 116b assigned to the second software application 106b. Based on the priority indicators 116a-b, the application scheduler 104 can schedule a respective execution of the software applications 106a-b such that the first software application 106a runs prior to the second software application 106b.

Although the priority indicators 116a-b are described in this example with respect to compliance with the safety standard, it will be appreciated that the priority indicators 116a-b can be assigned based on other factors. For example, the application scheduler 104 may assign the first priority indicator 116a to the first software application 106a based on sufficient computing resources being currently available to execute the first software application 106a. In contrast, the application scheduler 104 may assign the second priority indicator 116b to the second software application 106b to indicate that at least one system resource needed to execute the second software application 106b is unavailable.

In some examples, the application scheduler 104 can modify or otherwise control an allocation of the system resources 108. For example, the allocation of the system resources 108 between or among the software applications 106a-n may be determined based on a respective priority indicator. In particular, a respective share of each software application with respect to the allocation of the system resources 108 may correspond to a respective prioritization of the software applications 106a-n. The application scheduler 104 can distribute the system resources 108 such that the compliant applications receive a larger share of the system resources 108 compared to the noncompliant applications. Accordingly, the application scheduler 104 can minimize resource interference between the compliant applications and the noncompliant applications.

As another example, the application scheduler 104 can designate a subset of the system resources 108 as one or more protected resources 118. The protected resources 118 can be reserved for use by the compliant applications such that the noncompliant applications are unable to access the protected resources 118. For example, the application scheduler 104 may receive a resource hold request 120 associated with the first software application 106a to hold a portion of the system resources 108 to be used by the first software application 106a when executing. The portion of the system resources 108 can include at least one system resource of the system resources 108 or a specific allocation of a particular system resource (e.g., a percentage of memory). Based on the resource hold request 120, the application scheduler 104 can place a resource hold on the portion of the system resources 108 to generate the protected resources 118. Once the resource hold has been placed, other software applications (e.g., the second software application 106b) may be unable to access the portion of the system resources 108 that is on hold or reserved. As yet another example, the application scheduler 104 can set a limit (e.g., an upper bound or a lower bound) with respect to the system resources 108 allocated to certain software applications, such as noncompliant applications. The limit can enable a predefined amount of the system resources 108 to be reserved for the compliant applications to access and use.

While FIG. 1 depicts a specific arrangement of components, other examples can include more components, fewer components, different components, or a different arrangement of the components shown in FIG. 1. For instance, in other examples, the application scheduler 104 may include a separate rule engine to control the execution of the software applications 106a-n based on the availability of the system resources 108 and compliance of the software applications 106a-n with the safety standard. Additionally, any component or combination of components depicted in FIG. 1 can be used to implement the process(es) described herein.

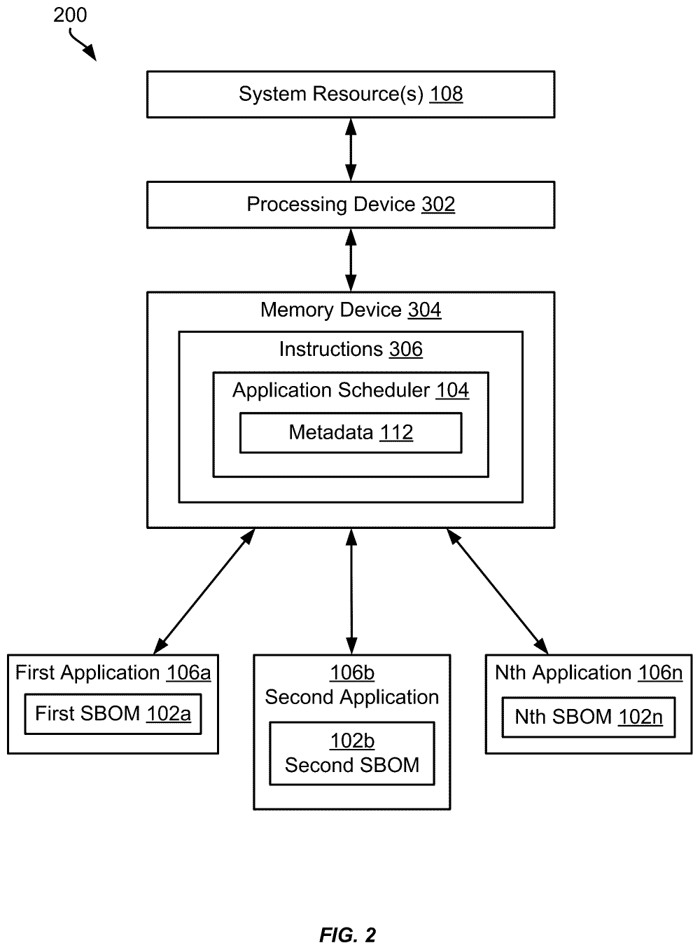

FIG. 2 is a block diagram of another example of a computing environment 200 for scheduling software execution using one or more software inventories (e.g., software bill of materials (SBOMs) 102a-n) to facilitate safety compliance according to some examples of the present disclosure. The computing environment 200 can include a processing device 202 communicatively coupled to a memory device 204. Certain aspects of FIG. 2 are described below with respect to components of FIG. 1.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

In some examples, the processing device 202 can control an execution of one or more software applications 106a-n (e.g., a first software application 106a and a second software application 106b) based on certain criteria to facilitate safety compliance. For example, the processing device 202 can obtain and analyze a respective SBOM of the software applications 106a-n to determine whether each software application is compliant or noncompliant with a functional safety standard. Each SBOM can include a respective set of metadata 112 that can provide an inventory of software components and hardware components corresponding to each software application. Additionally, based on the metadata 112 provided by the SBOMs 102a-n, the processing device 202 can determine a respective set of system resources 108 used to execute each software application. In particular, the respective sets of metadata 112 can indicate minimum resource requirements needed to execute a corresponding software application.

To ensure compliance with the functional safety standard, the processing device 202 can prioritize the execution of a subset of the software applications 106a-n that is compliant with the safety standard. In some cases, the compliant applications can provide one or more functionalities that contribute to the compliance with the functional safety standard. For example, in automotive applications, a particular compliant application may interface with a braking system of a vehicle to provide a fail-operational system with respect to slowing or stopping the vehicle. Accordingly, if the particular compliant application is unable to successfully execute, safety of the vehicle may be compromised. In contrast, the noncompliant applications may be unassociated with the functional safety standard.

To prevent noncompliant applications from interfering with the compliant applications, the processing device 202 can control the execution of the noncompliant applications to minimize resource contention with the compliant applications. In some implementations, the processing device 202 can prevent the execution of the second software application 106b until the first software application 106a has successfully executed to prevent resource contention from occurring. In one scenario, the execution of the second software application 106b can be put on hold or otherwise paused until the first software application 106a has run. In other implementations, the processing device 202 may execute a portion of the second software application 106b if the portion of the second software application 106b consumes system resources that are not needed by the first software application 106a.

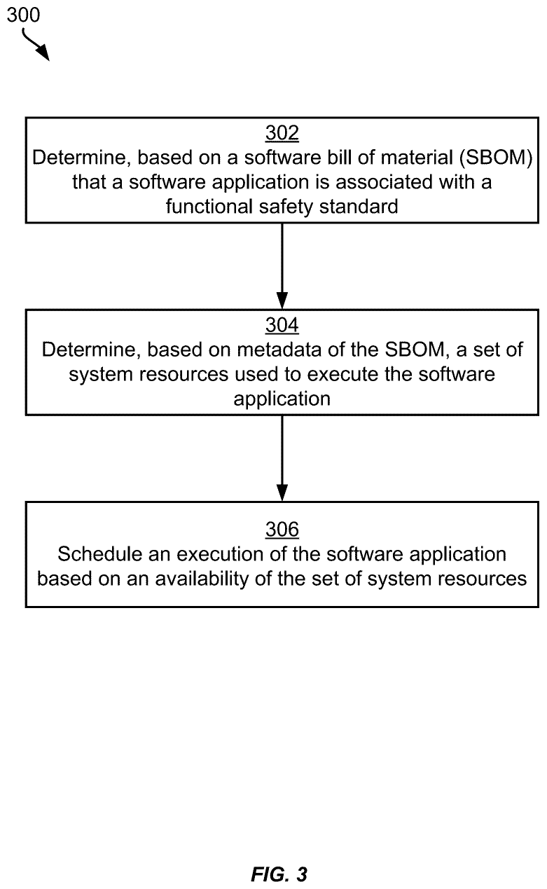

FIG. 3 is a flowchart of a process 300 for scheduling software execution using one or more software inventories (e.g., software bill of materials (SBOMs) 102a-n) to facilitate safety compliance according to some examples of the present disclosure. In some examples, the processing device 202 can perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

In block 302, the processing device 202 determines, based on a SBOM 102, that a software application 106 is associated with a functional safety standard. In some cases, the SBOM 102 can be packaged with the software application 106 when the software application 106 is released for installation. The SBOM 102 can include metadata 112 corresponding to the software application 106. The metadata 112 can describe contents of the software application 106, such as by providing an inventory of components in the software application 106 or by indicating dependencies associated with the software application 106. As an example, the processing device 202 can analyze the SBOM 102 of the software application 106 to determine that the software application 106 is compliant with a particular Automotive Safety Integrity Level (ASIL).

In block 304, the processing device 202 determines, based on the metadata 112 of the SBOM 102, a set of system resources 108 used to execute the software application 106. The processing device 202 can analyze the metadata 112 provided by the SBOM 102 to determine the set of the system resources 108 corresponding to the software application 106. For instance, the processing device 202 may apply one or more rule sets to extract the set of the system resources 108 from the metadata 112. Examples of the system resources 108 can include one or more devices communicatively coupled with the processing device 202, internal system components (e.g., RAM, CPU, storage, processing power, etc.), or a combination thereof. The set of system resources 108 can be specific to the software application 106 such that a different software application may use a different set of the system resources 108 for execution.

In block 306, subsequent to determining the set of system resources 108, the processing device 202 schedules an execution of the software application 106 based on an availability of the set of system resources 108 and the software application 106 being associated with the functional safety standard. The software application 106 being associated with the functional safety standard can indicate that a risk to human health associated with failure or malfunction of the software application 106 is relatively high. For example, the software application 106 may assist in preventing airbag failure in a vehicle. Accordingly, the processing device 202 can prioritize executing the software application 106 to prevent an interference event from occurring and potentially causing harm to humans.

To prevent a respective resource consumption of other software applications from interfering with the software application 106, the processing device 202 can avoid executing the software application 106 until sufficient system resources are available. For example, if all of the set of system resources 108 is available, the processing device 202 can execute the software application 106 immediately or arrange a time in the near future (e.g., within an hour or a day) to execute the software application 106. On the other hand, if at least one system resource of the set of system resources 108 is unavailable, the processing device 202 can avoid executing the software application 106 until the at least one system resource becomes available.

As another example, a portion of the set of system resources 108 may be available, while the remaining portion of the set of system resources 108 may be in use or otherwise occupied by other software applications. The processing device 202 can execute a subset of the software application 106 that uses the portion of the set of system resources 108 that is available. The rest of the software application 106 that is not executed may have insufficient system resources for execution due to the remaining portion of the set of system resources 108 being unavailable. To avoid causing an interference event, the processing device 202 may selectively execute the subset of the software application 106 that is supported by available system resources while preventing the rest of the software application 106 from executing.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
determining, based on a software inventory, that a software application is associated with a functional safety standard, the software inventory comprising metadata corresponding to the software application;
determining, based on the metadata of the software inventory, a set of system resources used to execute the software application; and
subsequent to determining the set of system resources, scheduling an execution of the software application based on an availability of the set of system resources and the software application being associated with the functional safety standard.

2. The system of claim 1, wherein scheduling the execution of the software application comprises:
determining that at least one system resource of the set of system resources is unavailable; and
preventing the execution of the software application until the at least one system resource is available.

3. The system of claim 2, wherein the operations further comprise:
determining that the at least one system resource will be available at a predefined time; and
in response to determining that the at least one system resource will be available at the predefined time, scheduling the execution of the software application to occur after the predefined time such that the set of system resources is available.

4. The system of claim 1, wherein scheduling the execution of the software application comprises:
determining, based on the availability of the set of system resources, that a portion of the software application lacks sufficient system resources to be executed; and
scheduling a partial execution of the software application such that a remaining portion of the software application is executed.

5. The system of claim 1, wherein the software inventory is a first software inventory associated with a first software application, and wherein the operations further comprise:
determining, based on a second software inventory, that a second software application is unassociated with the functional safety standard;
determining, based on the second software inventory, that a predicted resource consumption of the second software application conflicts with the set of system resources used to execute the first software application; and
assigning a respective priority to the first software application and the second software application to prioritize executing the first software application.

6. The system of claim 5, wherein the operations further comprise:
assigning at least one system resource of the set of system resources to the first software application to prevent the second software application from accessing the at least one system resource.

7. The system of claim 1, wherein the metadata of the software inventory indicates a minimum set of system resources to execute the software application.

8. A method comprising:
determining, based on a software inventory, that a software application is associated with a functional safety standard, the software inventory comprising metadata corresponding to the software application;
determining, based on the metadata of the software inventory, a set of system resources used to execute the software application; and
subsequent to determining the set of system resources, scheduling an execution of the software application based on an availability of the set of system resources and the software application being associated with the functional safety standard.

9. The method of claim 8, wherein scheduling the execution of the software application comprises:
determining that at least one system resource of the set of system resources is unavailable; and
preventing the execution of the software application until the at least one system resource is available.

10. The method of claim 9, further comprising:
determining that the at least one system resource will be available at a predefined time; and
in response to determining that the at least one system resource will be available at the predefined time, scheduling the execution of the software application to occur after the predefined time such that the set of system resources is available.

11. The method of claim 8, wherein scheduling the execution of the software application comprises:
determining, based on the availability of the set of system resources, that a portion of the software application lacks sufficient system resources to be executed; and
scheduling a partial execution of the software application such that a remaining portion of the software application is executed.

12. The method of claim 8, wherein the software inventory is a first software inventory associated with a first software application, and wherein the method further comprises:
determining, based on a second software inventory, that a second software application is unassociated with the functional safety standard;
determining, based on the second software inventory, that a predicted resource consumption of the second software application conflicts with the set of system resources used to execute the first software application; and
assigning a respective priority to the first software application and the second software application to prioritize executing the first software application.

13. The method of claim 12, further comprising:
receiving a resource hold request to reserve at least one system resource of the set of system resources to be used by the first software application; and
in response to receiving the resource hold request, assigning the at least one system resource to the first software application to prevent the second software application from accessing the at least one system resource.

14. The method of claim 8, wherein the metadata of the software inventory indicates a minimum set of system resources to execute the software application.

15. A non-transitory computer-readable medium comprising program code executable by a processing device for causing the processing device to perform operations comprising:
determining, based on a software inventory, that a software application is associated with a functional safety standard, the software inventory comprising metadata corresponding to the software application;
determining, based on the metadata of the software inventory, a set of system resources used to execute the software application; and
subsequent to determining the set of system resources, scheduling an execution of the software application based on an availability of the set of system resources and the software application being associated with the functional safety standard.

16. The non-transitory computer-readable medium of claim 15, scheduling the execution of the software application comprises:
determining that at least one system resource of the set of system resources is unavailable; and
preventing the execution of the software application until the at least one system resource is available.

17. The non-transitory computer-readable medium of claim 16, wherein the operations further comprise:
determining that the at least one system resource will be available at a predefined time; and
in response to determining that the at least one system resource will be available at the predefined time, scheduling the execution of the software application to occur after the predefined time such that the set of system resources is available.

18. The non-transitory computer-readable medium of claim 15, wherein scheduling the execution of the software application comprises:
determining, based on the availability of the set of system resources, that a portion of the software application lacks sufficient system resources to be executed; and
scheduling a partial execution of the software application such that a remaining portion of the software application is executed.

19. The non-transitory computer-readable medium of claim 15, wherein the software inventory is a first software inventory associated with a first software application, and wherein the operations further comprise:
determining, based on a second software inventory, that a second software application is unassociated with the functional safety standard;
determining, based on the second software inventory, that a predicted resource consumption of the second software application conflicts with the set of system resources used to execute the first software application; and
assigning a respective priority to the first software application and the second software application to prioritize executing the first software application.

20. The non-transitory computer-readable medium of claim 19, wherein the operations further comprise:
receiving a resource hold request to reserve at least one system resource of the set of system resources to be used by the first software application; and
in response to receiving the resource hold request, assigning the at least one system resource to the first software application to prevent the second software application from accessing the at least one system resource.
